(19) United States
(12) Patent Application Publication
(10) Pub. No.: US 2025/0145052 A1
(43) Pub. Date: May 8, 2025

(54) REDUNDANT ELECTRICAL POWER SYSTEM FOR VEHICLE

(71) Applicant: GM GLOBAL TECHNOLOGY OPERATIONS LLC, Detroit, MI (US)

(72) Inventors: Mohamed Kamel, Birmingham, MI (US); Anthony J. Corsetti, Rochester Hills, MI (US); Robert J. Heydel, Clawson, MI (US); Jonathan O. Conell, Sterling Heights, MI (US); Robert A.. DeStefano, Macomb, MI (US)

(73) Assignee: GM GLOBAL TECHNOLOGY OPERATIONS LLC, Detroit, MI (US)

(21) Appl. No.: 18/504,202

(22) Filed: Nov. 8, 2023

(51) Int. Cl. B60L 58/20; B60L 1/00

(52) U.S. Cl. CPC B60L 58/20; B60L 1/003

(57) ABSTRACT

An electrical power system. The electrical power system may include a rechargeable energy storage system (RESS) having a high voltage (HV) interface configured for exchanging HV power with one or more loads and a low voltage (LV) interface configured for exchanging LV power with a plurality of electrical grids a redundant distribution system having a plurality of busbars configured for redundantly connecting the electrical grids with the LV interface such that each of the electrical grids remains operable and connected to the LV interface during a disconnect event.

### INTRODUCTION

The present disclosure relates to electrical power systems, such as but not necessarily limited to electrical power systems operable onboard vehicles to redundantly provide electrical power to multiple grids.

A vehicle may include an electric motor for converting electrical power to mechanical power for purposes of utilizing the mechanical power to perform work, such as to mechanically power a drivetrain to propel the vehicle. Such vehicles may include a rechargeable energy storage system (RESS) for storing and supplying electrical power, typically with the RESS connecting to the electric motor via a high voltage (HV) interface. Given the relatively vast amount of electrical power available from the RESS, it may be desirable to also use that electrical power to power other devices, systems, etc. onboard the vehicle. A vehicle may include a wide array of electrical loads operating at relatively lower voltages than the electric motor, with some vehicles including one or more low voltage (LV) grids, buses, etc. for purposes of powering related LV loads. In the past, such vehicles have included a separately operable LV battery connected to one or more of the LV grids for purposes of assuring a supply of electrical power to the LV loads should the RESS experience a disconnect event or other issue whereby the RESS itself and/or its distribution system be unable to reliably supply electrical power to the LV grids.

### SUMMARY

One non-limiting aspect of the present disclosure relates to a vehicle electrical system having a redundant distribution configuration whereby electrical power may be reliably provided to low voltage (LV) grids, buses, etc. during a disconnect event, such as during an event resulting from a busbar or other connection being unavailable due to do a driving or other incident. The redundant distribution configuration may be advantageous in eliminating or ameliorating the need for an LV battery or other backup system to supply electrical power to the LV grids independently of a rechargeable energy storage system (RESS).

One non-limiting aspect of the present disclosure relates to an electrical power system for a vehicle having a traction motor and a plurality of electrical grids. The system may include a rechargeable energy storage system (RESS) having a high voltage (HV) interface configured for exchanging HV power with the traction motor and a low voltage (LV) interface configured for exchanging LV power with the electrical grids. The system may further include a redundant distribution system having a plurality of busbars configured for redundantly connecting the electrical grids with the LV interface such that each of the electrical grids remains operable and connected to the LV interface during a disconnect event.

The electrical grids each may include a LV bus configured for distributing the LV power to one or more loads and the busbars may be arranged in a redundant configuration characterized by each of the LV buses being independently connectable to two or more of the busbars.

The system may include a plurality of aggregating units each having a plurality of inputs commonly connectable to an output. The aggregating units each may include the output connected to one of the LV buses of the electrical grids and the inputs separately connected to one of the two or more of the busbars.

The RESS may include a plurality of cell groups and a plurality of power converters, the power converters each operable for converting electrical power from one or more of the cell groups into a plurality of LV outputs, optionally with each of the LV outputs correspondingly delivering LV power to a connected to one of the busbars.

The electrical grids may include a first grid and a second grid, and the aggregating units may include a first unit and a second unit such that the unit inputs of the first unit include a first primary input and a first secondary input, the unit output of the first unit connects to the first grid, the unit inputs of the second unit include a second primary input and a second secondary input, and the unit output of the second unit connects to the second grid.

The LV outputs of each of the power converters may include a first LV output and a second LV output and the busbars may include a first busbar and a second busbar such that the first busbar connects to each of the first LV outputs and the first and second primary inputs and the second busbar connects to each of the second LV outputs and the first and second secondary inputs.

The LV outputs of each of the power converters may include a first LV output and a second LV output. The system may further include a junction having a first junction input connectable to a junction output via a first switch or fuse and a second junction input connectable to the junction output via a second switch or fuse. The busbars may include a first busbar, a second busbar, a third busbar such that the first busbar connects to each of the first LV outputs, the first primary input, and the first junction input, the second busbar connects to each of the second LV outputs, the second secondary input, and the second junction input, and the third busbar connects to the first secondary input, the second primary input, and the junction output.

The LV outputs of each of the power converters may include a first LV output, a second LV output, and a third LV output and the busbars may include a first busbar, a second busbar, and a third busbar such that the first busbar connects to each of the first LV outputs and the first primary input, the second busbar connects to each of the second LV outputs and the second secondary input, and the third busbar connects to each of the third LV outputs, the first secondary input, and the second primary input.

The LV outputs of each of the power converters may include a first LV output, a second LV output, and a third LV output. The system may further include a junction box having a junction input connected to a first junction output via a first switch or fuse and a second switch or fuse and to a second junction output via the first switch or fuse and a third switch or fuse. The busbars may include a first busbar, a second busbar, a third busbar such that the first busbar connects to each of the first LV outputs and the first primary input, the second busbar connects to each of the second LV outputs and the second secondary input, and the third busbar connects to each of the third LV outputs, the first secondary input, the second primary input, the junction input and the first and second junction outputs.

The LV outputs of a primary side of the power converters may each include a first LV output and a second LV output, and the LV outputs of a secondary side of the power converters may each include a third LV output and a fourth LV output. The busbars may include a first busbar, a second busbar, a third busbar, and a fourth busbar such that the first busbar connects to each of the first LV outputs and the first primary input, the second busbar connects to each of the second LV outputs and the first secondary input, the third busbar connects to each of the third LV outputs and the second secondary input, and the fourth busbar connects to each of the fourth LV outputs and the first primary input.

The LV outputs of a primary side of a first plurality of the power converters each may include a first LV output and a second plurality of the power converters each include a second LV output, and the LV outputs of a secondary side of a third plurality of the power converters may each include a third LV output and a fourth plurality of the power converters each include a fourth LV output. The busbars may include a first busbar, a second busbar, a third busbar, and a fourth busbar such that the first busbar connects to each of the first LV outputs and the second secondary input, the second busbar connects to each of the second LV outputs and the second primary input, the third busbar connects to each of the third LV outputs and the first secondary input, and the fourth busbar connects to each of the fourth LV outputs and the first primary input.

The electrical grids may include a first grid and a second grid, and the aggregating units may include a first unit and a second unit. The unit inputs of the first unit may include a first primary input, a first secondary input, and a first tertiary input with the unit output of the first unit connecting to the first grid. The unit inputs of the second unit may include a second primary input, a second secondary input, and a second tertiary input with the unit output of the second unit connecting to the second grid. The LV outputs of a primary side of the power converters each may include a first LV output and a second LV output, and the LV outputs of a secondary side of the power converters each may include a third LV output and a fourth LV output. The busbars may include a first busbar, a second busbar, a third busbar, a fourth busbar, and a fifth busbar such that the first busbar connects to each of the first LV outputs and the second primary input, the second busbar connects to each of the second LV outputs and the second secondary input, the third busbar connects to each of the third LV outputs and the first secondary input, the fourth busbar connects to each of the fourth LV outputs and the first primary input, and the fifth busbar connects to the first tertiary input and the second tertiary input.

The aggregating units may each include a plurality of fuses for connecting the one of the LV buses with the two or more of busbars.

The aggregating units may each include a plurality of switches for selectively connecting and disconnecting the inputs and the output.

The busbars may each have approximately the same length and the same impedance.

The disconnect event may correspond with one of the busbars experiencing an open circuit condition.

The disconnect event may correspond with one of the LV outputs experiencing an open circuit condition.

One non-limiting aspect of the present disclosure relates to an electrical power system for a vehicle having a traction motor and a plurality of electrical grids. The system may include a rechargeable energy storage system (RESS) having a high voltage (HV) interface configured for exchanging HV power with the traction motor and a low voltage (LV) interface configured for exchanging LV power with the electrical grids with the electrical grids each including a LV bus configured for distributing the LV power to one or more loads. The system may further include a redundant distribution system having a plurality of busbars arranged in a redundant configuration characterized by each of the LV buses being independently connectable to the LV interface via two or more of the busbars such that each of the electrical grids remains operable and connected to the LV interface during a disconnect event whereby one of the busbars experiences an open circuit condition.

The system may include a plurality of aggregating units having a plurality of unit inputs commonly connectable to a unit output, optionally with the aggregating units each including the unit output connected to one of the LV buses of the electrical grids and the unit inputs separately connected to one of the two or more of the busbars connectable thereto.

One non-limiting aspect of the present disclosure relates to an electrical power system. The system may include a rechargeable energy storage system (RESS) having a high voltage (HV) interface configured for exchanging HV power with one or more loads and a low voltage (LV) interface configured for exchanging LV power with a plurality of electrical grids. The system may further include a redundant distribution system having a plurality of busbars configured for redundantly connecting the electrical grids with the LV interface such that each of the electrical grids remains operable and connected to the LV interface during a disconnect event.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a schematic view of a vehicle in accordance with one non-limiting aspect of the present disclosure.

FIG. 2 illustrates a schematic diagram of an electrical power system having a redundant distribution configuration in accordance with one non-limiting aspect of the present disclosure.

FIG. 3 illustrates a schematic diagram of an electrical power system having a redundant distribution configuration in accordance with one non-limiting aspect of the present disclosure.

FIG. 4 illustrates a schematic diagram of an electrical power system having a redundant distribution configuration in accordance with one non-limiting aspect of the present disclosure.

FIG. 5 illustrates a schematic diagram of an electrical power system having a redundant distribution configuration in accordance with one non-limiting aspect of the present disclosure.

FIG. 6 illustrates a schematic diagram of an electrical power system having a redundant distribution configuration in accordance with one non-limiting aspect of the present disclosure.

FIG. 7 illustrates a schematic diagram of an electrical power system having a redundant distribution configuration in accordance with one non-limiting aspect of the present disclosure.

FIG. 8 illustrates a schematic diagram of an electrical power system having a redundant distribution configuration in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

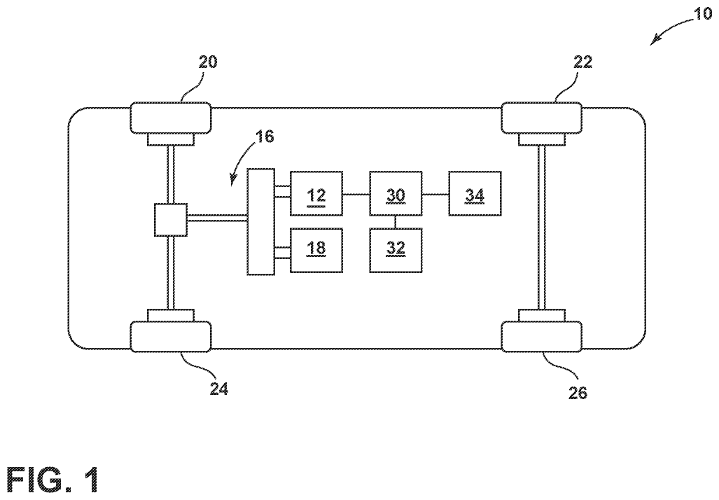

FIG. 1 illustrates a schematic view of a vehicle 10 in accordance with one non-limiting aspect of the present disclosure. The vehicle 10, which may be interchangeable referred to as an electric or hybrid vehicle 10, may include an electric motor 12 operable for converting electrical power to mechanical power for purposes of performing work, such as to mechanically power a drivetrain 16 to propel the vehicle. The vehicle 10 is illustrated as a hybrid type due to the powertrain 16 optionally including an internal combustion engine (ICE) 18 for generating mechanical power. The powertrain 16 may include a transmission, a driveshaft, a differential, axles and/or other componentry to facilitate conveying rotative force from the electric motor 12 to one or more of the wheels 20, 22, 24, 26. The vehicle 10 may include a rechargeable energy storage system (RESS) 30, which may be referred to as a battery pack 30, for storing and supplying electrical power for the electric motor 12 and/or other system, buses, etc. connected to one or more electrical grids 34 onboard the vehicle 10. The vehicle 10 may include a battery monitoring system or controller 32 to facilitate monitoring, controlling, measuring, and otherwise directing operation, performance, etc. onboard the vehicle 10.

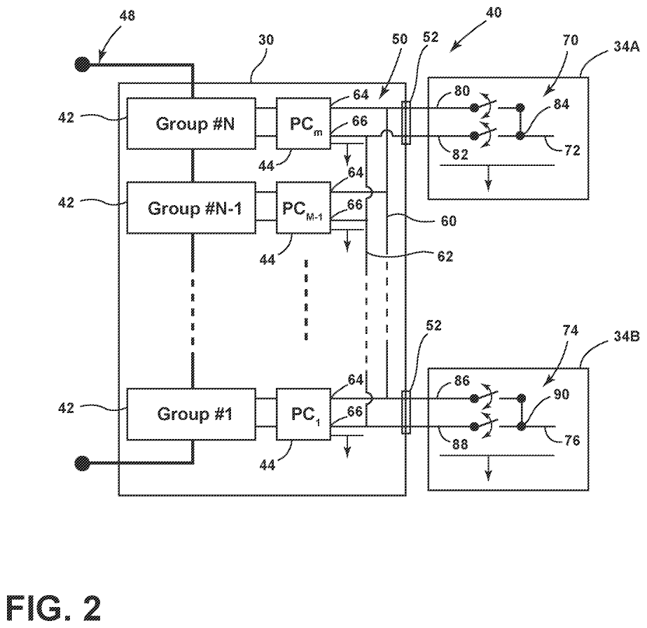

FIG. 2 illustrates a schematic diagram of an electrical power system 40 having a redundant distribution configuration in accordance with one non-limiting aspect of the present disclosure. The electrical power system 40 may be operable for redundantly providing electrical power from the RESS 30 to the electrical grids 34, which are shown for exemplary purposes to include a first electrical grid 34A and a second electrical grid 34B as more or less electrical grids may be included. The RESS 30 may be of the type having a plurality of battery cells arranged according to a plurality of battery groups 42, with each battery group being associated with a power converter 44. The power converters 44 may be unidirectional and/or bidirectional direct current (DC) to DC (DC-DC) converters or other types of devices operable for managing power transfer. The RESS 30 may include a high voltage (HV) interface 48 and a low voltage (LV) interface 50, with the HV interface 48 operable for exchanging HV electrical power with the electric motor 12 and/or an HV bus and the LV interface 50 operable via a first connection 52 and a second connection 54 for respectively exchanging LV electrical power with the first and second grids 34A, 34B. The electrical grids 34A, 34B are described with respect to being reliant upon DC power for non-limiting purposes as the present disclosure contemplates one or more of the electrical grids utilizing alternating current (AC) power, which may relatedly include one or more of the power converters 44 being a DC-AC converter.

The electrical power system 40 may be configured to provide a redundant distribution system having a plurality of busbars 60, 62 configured for redundantly connecting the electrical grids 34A, 34B with the LV interface 50. The redundant configuration may be operable for maintaining operability of the electrical grids 34A, 34B during a disconnect event, such as during an event resulting from one of the busbars 60, 62 and/or other connection being unavailable due to do a driving or other incident. The redundant distribution configuration may be advantageous in eliminating or ameliorating the need for an LV battery or other backup system to supply electrical power for the LV grids 34A, 34B independently of the RESS 30 during normal operation, i.e., the electrical grids 34A, 34B may be entirely reliant upon an exchange of electric power with the RESS 30. The vehicle 10 may include charging modules or other features (not shown) to facilitate charging the RESS 30 and/or providing power to the electrical grids 34A, 34B via charging stations, utility grids, etc. from additional sources offboard the vehicle. The present disclosure contemplates the RESS 30 including other configurations, including those that may not rely upon separate branches for each battery groups 42 and the power converters 44, which may in turn result in differing arrangements for the busbars 60, 62.

In the illustrated configuration, each of the power converters 44 may be configured for providing a first LV output 64 and a second LV output 66, optionally with the first and second LV outputs 64, 66 being approximately the same or different. The busbars may include the first busbar 60 connected to each of the first LV outputs 64 and the second busbar 62 connected to each of the second LV outputs 66. The first electrical grid 34A may include a first aggregating unit 70 operable to facilitate connecting a first LV bus 72 with the first and second busbars 60, 62, and the second electrical grid 34B may likewise include a second aggregating unit 74 operable to facilitate connecting a second LV bus 76 with the first and second busbars 60, 62. The first aggregating unit 70 may include a first primary input 80 and a first secondary input 82 commonly connected to a first output 84, and the second aggregating unit 74 may likewise include a second primary input 86 and a second secondary input 88 commonly connected to a second output 90. The inputs and outputs 80, 82, 86, 88 are shown to be connectable to the outputs 84, 90 via a plurality of switches, such as semiconductor, transistor, etc. switches, operable between opened and/or closed positions according to commands received from the controller, however, fuses or other mechanism may be used to provide selectable and/or fixed connections between the inputs and the outputs. A ground (not labeled) is shown to represent the power converters 44, the electrical grids 34A, 34B, etc. connected to a vehicle ground, as one skilled in the art may appreciate to facilitate the operations and configurations contemplated herein.

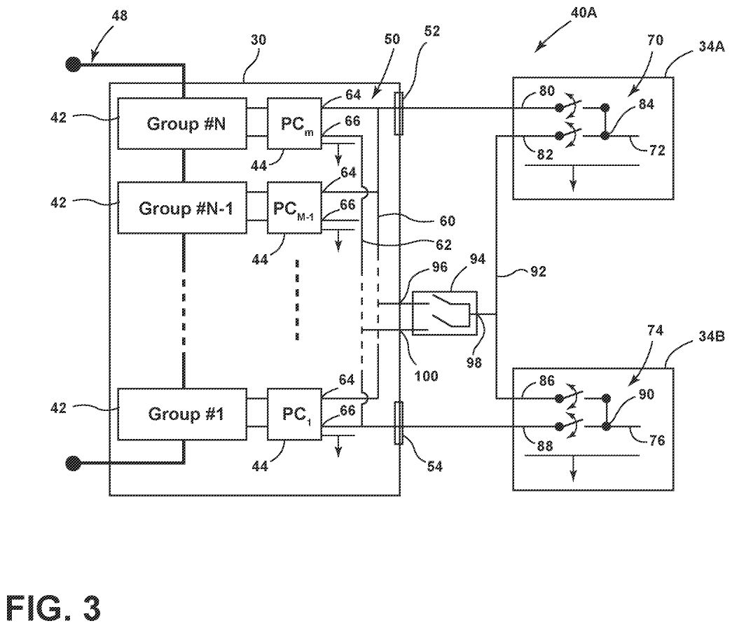

FIG. 3 illustrates a schematic diagram of an electrical power system 40A having a redundant distribution configuration in accordance with one non-limiting aspect of the present disclosure. The electrical system 40A may be differentiated based on including a third busbar 92 and a junction box 94. The power converters 44 may be configured for providing a first LV output 64 and a second LV output 66. The junction box 94 may include a first junction input 96 connectable to a junction output 98 via a first switch or fuse and a second junction input 100 connectable to the junction output 98 via a second switch or fuse. The first busbar 60 may connect to each of the first LV outputs 64, the first primary input 80, and the first junction input 96. The second busbar 62 may connect to each of the second LV outputs 66, the second secondary input 88, and the second junction input 100. The third busbar 92 may connect to the first secondary input 82, the second primary input 86, and the junction output 98.

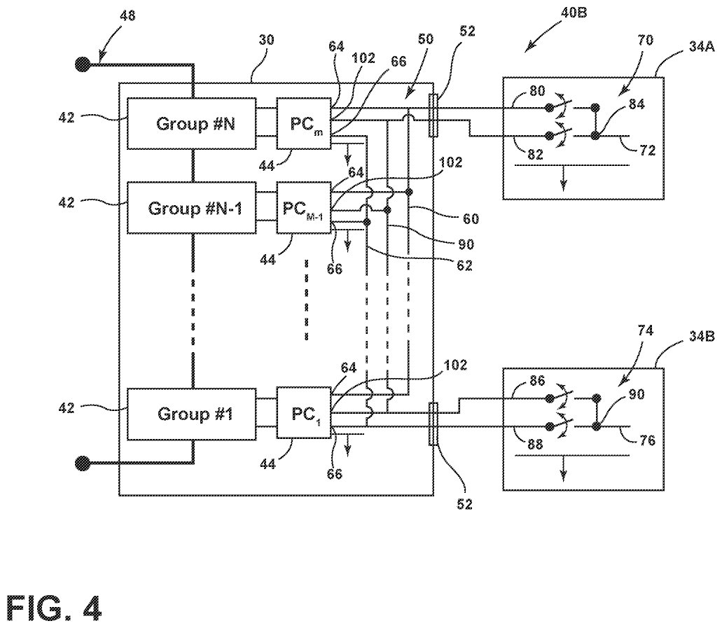

FIG. 4 illustrates a schematic diagram of an electrical power system 40B having a redundant distribution configuration in accordance with one non-limiting aspect of the present disclosure. The electrical system 40B may be differentiated based on including a third busbar 92 and each of the power converters including a third LV output 102. The power converters 44 may be configured for providing a first LV output 64 and a second LV output 66. The first busbar 60 may connect to each of the first LV outputs 64 and the first primary input 80. The second busbar 62 may connect to each of the second LV outputs 66 and the second secondary input 88. The third busbar 92 may connect to each of the third LV outputs 102, the first secondary input 82, and the second primary input 86.

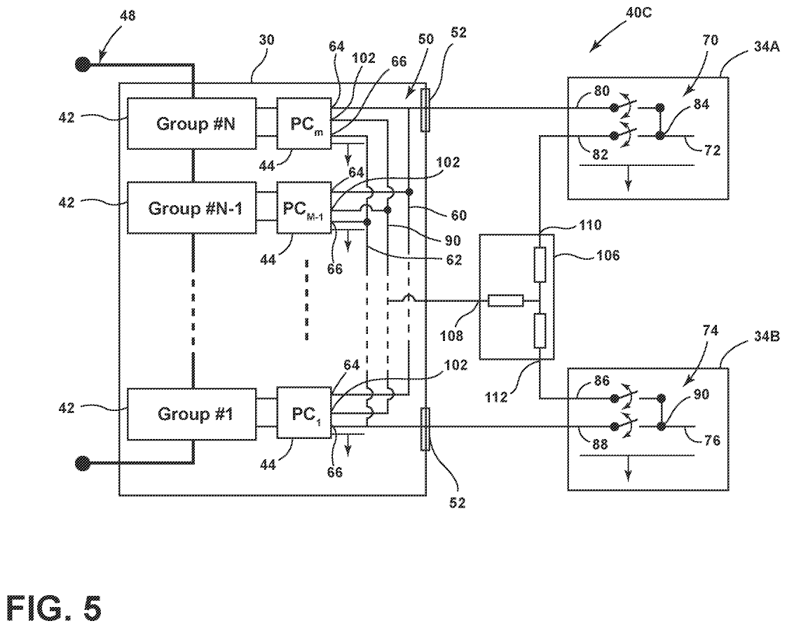

FIG. 5 illustrates a schematic diagram of an electrical power system 40C having a redundant distribution configuration in accordance with one non-limiting aspect of the present disclosure. The electrical system 40C may be differentiated based on a third busbar 92, a third LV output 102, and a junction box 106 having input 108 and first and second outputs 110, 112. The first busbar 60 may connect to each of the first LV outputs 64 and the first primary input 80. The second busbar 62 may connect to each of the second LV outputs 66 and the second secondary input 88. The third busbar 92 may connect to each of the third LV outputs 102, the first secondary input 82, the second primary input 86, the junction input 108, and the first and second junction outputs 110, 112.

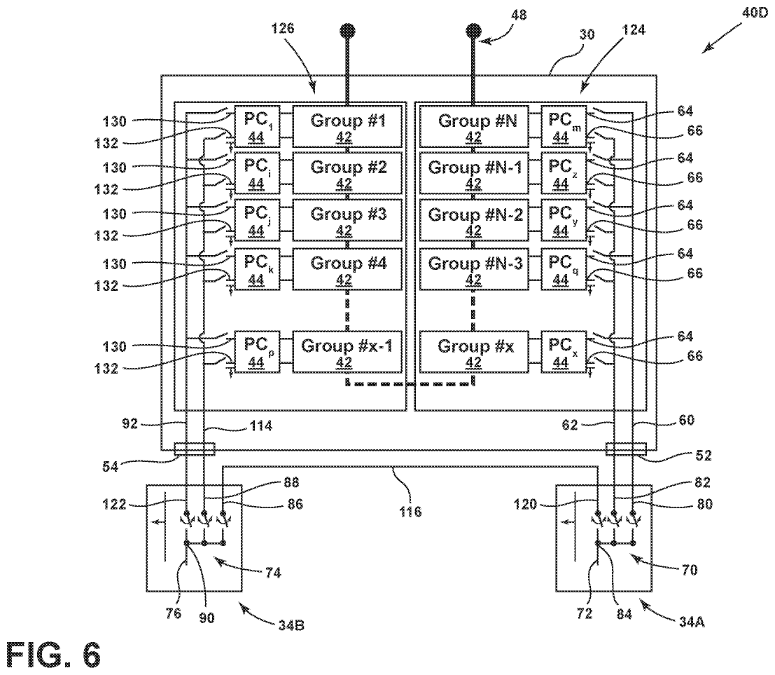

FIG. 6 illustrates a schematic diagram of an electrical power system 40D having a redundant distribution configuration in accordance with one non-limiting aspect of the present disclosure. The electrical system 40D may include a first busbar 60, a second busbar 62, a third busbar 92, a fourth busbar 114, a fifth busbar 116, and the aggregating units 70, 74 having an additional, tertiary input 120, 122. A primary side 124 of the power converters 44 may each include a first LV output 64 and a second LV output 66, and a secondary side 126 of the power converters 44 may each include a third LV output 130 and a fourth LV output 132. The first busbar 60 may connect to each of the first LV outputs 64 and the first primary input 80. The second busbar 62 may connect to each of the second LV outputs 66 and the first secondary input 82. The third busbar 92 may connect to each of the third LV outputs 130 and the second tertiary input 122. The fourth busbar 114 may connect to each of the fourth LV outputs 132 and the second secondary input 88. The fifth busbar 116 may connect to the first tertiary input 120 and the second primary input 86.

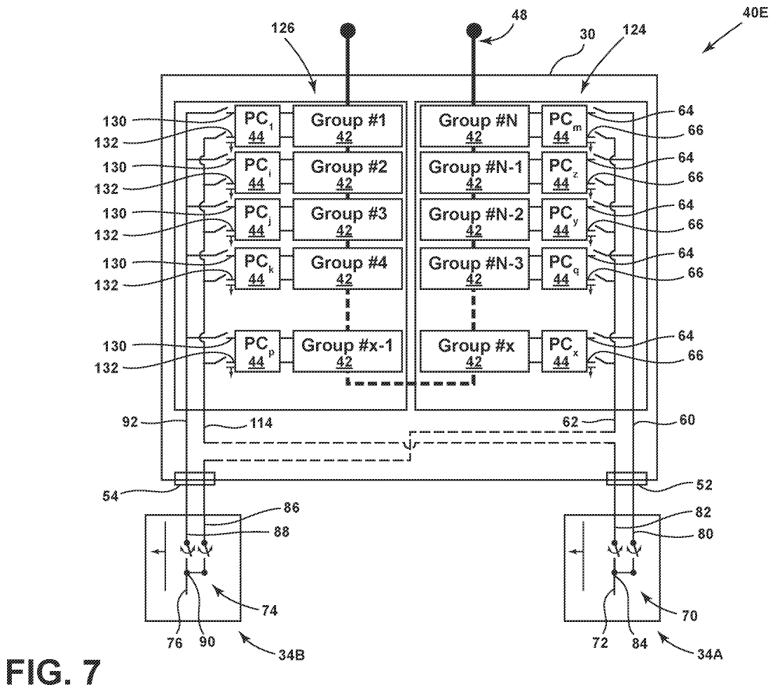

FIG. 7 illustrates a schematic diagram of an electrical power system 40E having a redundant distribution configuration in accordance with one non-limiting aspect of the present disclosure. The electrical system 40E may be differentiated based including a third busbar 92 and a fourth busbar 114. The LV outputs of a primary side 124 of the power converters 44 may each include a first LV output 64 and a second LV output 66, and the LV outputs of a secondary side 126 of the power converters 44 may each include a third LV output 130 and a fourth LV output 132. The first busbar 60 may connect to each of the first LV outputs 64 and the first primary input 80. The second busbar 62 may connect to each of the second LV outputs 66 and the second primary input 86. The third busbar 92 may connect to each of the third LV outputs 130 and the second secondary input 88. The fourth busbar 114 may connect to each of the fourth LV outputs 132 and the first secondary input 82.

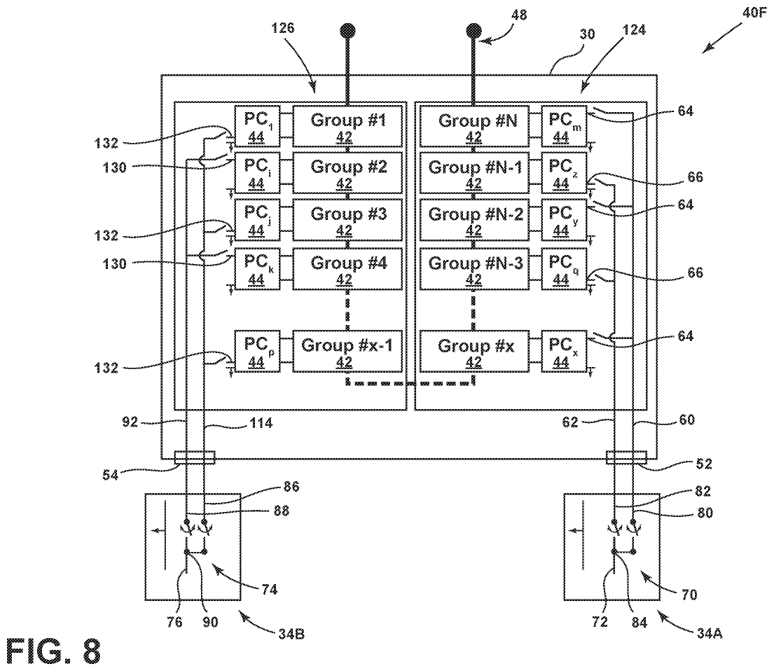

FIG. 8 illustrates a schematic diagram of an electrical power system 40F having a redundant distribution configuration in accordance with one non-limiting aspect of the present disclosure. The electrical system 40F may be differentiated based including the third and fourth busbars 92, 114 connected in a different manner. The LV outputs of a primary side 124 of a first plurality of the power converters 44 may each include a first LV output 64 and a second plurality of the power converters 44 each include a second LV output 66, and the LV outputs of a secondary side 126 of a third plurality of the power converters 44 may each include a third LV output 130 and a fourth plurality of the power converters 44 may each include a fourth LV output 132. The first busbar 60 may connect to each of the first LV outputs 64 and the first primary input 80. The second busbar 62 may connect to each of the second LV outputs 66 and the first secondary input 82. The third busbar 92 may connect to each of the third LV outputs 130 and the second secondary input 88. The fourth busbar 114 may connect to each of the fourth LV outputs 132 and the second primary input 86. The length, diameter, connected to one of the power converters, shape, etc. of the busbars 60, 62, 92, 114 may be varied or sized to correspondingly adjust the resistances between the power converters 44 and the buses 72, 76.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An electrical power system for a vehicle having a traction motor and a plurality of electrical grids, comprising:
a rechargeable energy storage system (RESS) having a high voltage (HV) interface configured for exchanging HV power with the traction motor and a low voltage (LV) interface configured for exchanging LV power with the electrical grids; and
a redundant distribution system having a plurality of busbars configured for redundantly connecting the electrical grids with the LV interface such that each of the electrical grids remains operable and connected to the LV interface during a disconnect event.

2. The electrical power system according to claim 1, wherein:
the electrical grids each include a LV bus configured for distributing the LV power to one or more loads; and
the busbars are arranged in a redundant configuration characterized by each of the LV buses being independently connectable to two or more of the busbars.

3. The electrical power system according to claim 2, further comprising:
a plurality of aggregating units each having a plurality of inputs commonly connectable to an output, wherein the aggregating units each include the output connected to one of the LV buses of the electrical grids and the inputs separately connected to one of the two or more of the busbars.

4. The electrical power system according to claim 3, wherein:
the RESS includes a plurality of cell groups and a plurality of power converters, the power converters each operable for converting electrical power from one or more of the cell groups into a plurality of LV outputs, each of the LV outputs correspondingly delivering LV power to a connected to one of the busbars.

5. The electrical power system according to claim 4, wherein:
the electrical grids include a first grid and a second grid; and
the aggregating units include a first unit and a second unit, wherein:
the unit inputs of the first unit include a first primary input and a first secondary input;
the unit output of the first unit connects to the first grid;
the unit inputs of the second unit include a second primary input and a second secondary input; and
the unit output of the second unit connects to the second grid.

6. The electrical power system according to claim 5, wherein:
the LV outputs of each of the power converters include a first LV output and a second LV output; and
the busbars include a first busbar and a second busbar, wherein:
the first busbar connects to each of the first LV outputs and the first and second primary inputs; and
the second busbar connects to each of the second LV outputs and the first and second secondary inputs.

7. The electrical power system according to claim 5, further comprising:
the LV outputs of each of the power converters including a first LV output and a second LV output;
a junction box having a first junction input connectable to a junction output via a first switch or fuse and a second junction input connectable to the junction output via a second switch or fuse; and
the busbars including a first busbar, a second busbar, a third busbar, wherein:
the first busbar connects to each of the first LV outputs, the first primary input, and the first junction input;
the second busbar connects to each of the second LV outputs, the second secondary input, and the second junction input; and
the third busbar connects to the first secondary input, the second primary input, and the junction output.

8. The electrical power system according to claim 5, wherein:
the LV outputs of each of the power converters include a first LV output, a second LV output, and a third LV output; and
the busbars include a first busbar, a second busbar, and a third busbar, wherein:
the first busbar connects to each of the first LV outputs and the first primary input;
the second busbar connects to each of the second LV outputs and the second secondary input; and
the third busbar connects to each of the third LV outputs, the first secondary input, and the second primary input.

9. The electrical power system according to claim 5, further comprising:
the LV outputs of each of the power converters including a first LV output, a second LV output, and a third LV output;
a junction box having a junction input connected to a first junction output via a first switch or fuse and a second switch or fuse and to a second junction output via the first switch or fuse and a third switch or fuse; and
the busbars including a first busbar, a second busbar, a third busbar, wherein:
the first busbar connects to each of the first LV outputs and the first primary input;
the second busbar connects to each of the second LV outputs and the second secondary input; and
the third busbar connects to each of the third LV outputs, the first secondary input, the second primary input, the junction input and the first and second junction outputs.

10. The electrical power system according to claim 5, wherein:
the LV outputs of a primary side of the power converters each include a first LV output and a second LV output, and the LV outputs of a secondary side of the power converters each include a third LV output and a fourth LV output; and
the busbars include a first busbar, a second busbar, a third busbar, and a fourth busbar, wherein:
the first busbar connects to each of the first LV outputs and the first primary input;
the second busbar connects to each of the second LV outputs and the first secondary input;
the third busbar connects to each of the third LV outputs and the second secondary input; and
the fourth busbar connects to each of the fourth LV outputs and the first primary input.

11. The electrical power system according to claim 5, wherein:
the LV outputs of a primary side of a first plurality of the power converters each include a first LV output and a second plurality of the power converters each include a second LV output, and the LV outputs of a secondary side of a third plurality of the power converters each include a third LV output and a fourth plurality of the power converters each include a fourth LV output; and
the busbars include a first busbar, a second busbar, a third busbar, and a fourth busbar, wherein:
the first busbar connects to each of the first LV outputs and the second secondary input;
the second busbar connects to each of the second LV outputs and the second primary input;
the third busbar connects to each of the third LV outputs and the first secondary input; and
the fourth busbar connects to each of the fourth LV outputs and the first primary input.

12. The electrical power system according to claim 4, wherein:
the electrical grids include a first grid and a second grid; and
the aggregating units include a first unit and a second unit, wherein:
the unit inputs of the first unit include a first primary input, a first secondary input, and a first tertiary input;
the unit output of the first unit connects to the first grid;
the unit inputs of the second unit include a second primary input, a second secondary input, and a second tertiary input; and
the unit output of the second unit connects to the second grid;
the LV outputs of a primary side of the power converters each include a first LV output and a second LV output, and the LV outputs of a secondary side of the power converters each include a third LV output and a fourth LV output; and
the busbars include a first busbar, a second busbar, a third busbar, a fourth busbar, and a fifth busbar, wherein:
the first busbar connects to each of the first LV outputs and the second primary input;
the second busbar connects to each of the second LV outputs and the second secondary input;
the third busbar connects to each of the third LV outputs and the first secondary input;
the fourth busbar connects to each of the fourth LV outputs and the first primary input; and
the fifth busbar connects to the first tertiary input and the second tertiary input.

13. The electrical power system according to claim 3, wherein:
the aggregating units each include a plurality of fuses for connecting the one of the LV buses with the two or more of busbars.

14. The electrical power system according to claim 3, wherein:
the aggregating units each include a plurality of switches for selectively connecting and disconnecting the inputs and the output.

15. The electrical power system according to claim 2, wherein:
the busbars each have approximately the same length and the same impedance.

16. The electrical power system according to claim 2, wherein:
the disconnect event corresponds with one of the busbars experiencing an open circuit condition.

17. The electrical power system according to claim 2, wherein:
the disconnect event corresponds with one of the LV outputs experiencing an open circuit condition.

18. An electrical power system for a vehicle having a traction motor and a plurality of electrical grids, comprising:
a rechargeable energy storage system (RESS) having a high voltage (HV) interface configured for exchanging HV power with the traction motor and a low voltage (LV) interface configured for exchanging LV power with the electrical grids, wherein the electrical grids each include a LV bus configured for distributing the LV power to one or more loads; and
a redundant distribution system having a plurality of busbars arranged in a redundant configuration characterized by each of the LV buses being independently connectable to the LV interface via two or more of the busbars such that each of the electrical grids remains operable and connected to the LV interface during a disconnect event whereby one of the busbars experiences an open circuit condition.

19. The electrical power system according to claim 18, further comprising:
a plurality of aggregating units having a plurality of unit inputs commonly connectable to a unit output, wherein the aggregating units each include the unit output connected to one of the LV buses of the electrical grids and the unit inputs separately connected to one of the two or more of the busbars connectable thereto.

20. An electrical power system, comprising:
a rechargeable energy storage system (RESS) having a high voltage (HV) interface configured for exchanging HV power with one or more loads and a low voltage (LV) interface configured for exchanging LV power with a plurality of electrical grids; and
a redundant distribution system having a plurality of busbars configured for redundantly connecting the electrical grids with the LV interface such that each of the electrical grids remains operable and connected to the LV interface during a disconnect event.
